(19) United States
(12) Patent Application Publication
(10) Pub. No.: US 2005/0025865 A1
(43) Pub. Date: Feb. 3, 2005

(54) Treating fresh meat with carbon monoxide

(76) Inventor: Guy L. Foulke JR., Hilton Head Island, SC (US)

Correspondence Address: Timothy N. Trop;TROP, PRUNER & HU, P.C., Suite 100, 8554 Katy Freeway, Houston, TX, 77024-1841, US

(21) Appl. No.: 10/851,511

(22) Filed: May 21, 2004

Related U.S. Application Data
(60) Provisional application No. 60/490,718, filed on Jul. 29, 2003.

(51) Int. Cl. A23L 1/27

(52) U.S. Cl. 426/316

(57) ABSTRACT

A method for the treatment of fresh meat in a pressure chamber having an atmosphere containing at least 0.1% carbon monoxide at a pressure of greater than 1.1 bar above the atmospheric pressure. The carbon monoxide treatment may be completed in less than seven hours.

### CROSS-REFERENCE TO RELATED APPLICATIONS

This application is based on provisional application 60/490,718, filed Jul. 29, 2003.

### BACKGROUND

The present invention relates to treating fresh beef, pork, veal, lamb, game, poultry, horsemeat, fish, raw sausages and ham, or any other fresh meat whose red color should be maintained while it is offered for sale.

Fresh meat may be treated with a gas mixture containing carbon monoxide (CO) in order to give the fresh meat a red color closely approaching the color of the meat soon after cutting. By treating fresh meat with this gas mixture the carbon monoxide reacts with the myoglobin or the oxymyoglobin in the red meat resulting in a stable red pigment, carbon-monoxide myoglobin, (carboxymyoglobin) which has substantially the same color as the color of freshly cut meat.

Without treatment, the red color of fresh meat can be maintained only for about two or three days. With carbon monoxide treatment, the red color can be maintained up to twenty to thirty days. However, existing techniques have not gained significant market share.

Thus, there is a need for better ways to treat fresh meat with carbon monoxide.

### BRIEF DESCRIPTION OF THE DRAWINGS

FIG. 1 is a schematic depiction of one embodiment of the present invention; and

FIG. 2 is a flow chart for one embodiment of the present invention.

### DETAILED DESCRIPTION

There are various problems in the treatment of fresh meat with carbon monoxide. Maintenance of the red color of the meat, resulting from the generation of carbon-monoxide myoglobin, after which the meat is no longer fit for human consumption due to microbiological factors, is undesirable. Also, due to the toxicology of carbon monoxide, workers performing the treatment and packaging and the consumer should not be subjected to toxic levels of carbon monoxide.

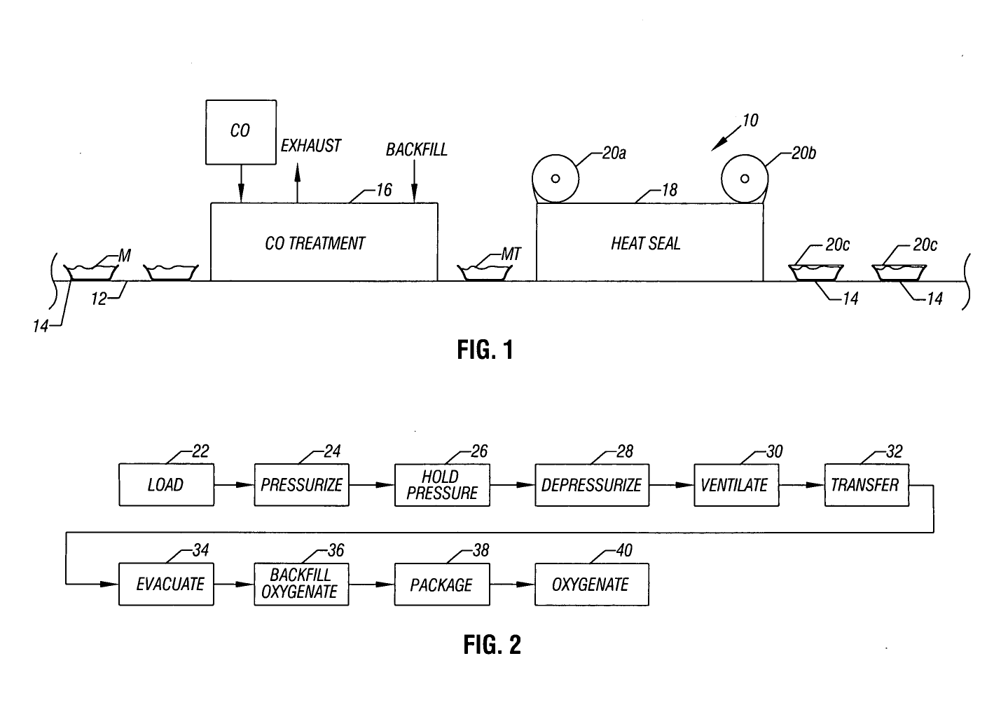

Referring to FIG. 1, trays 14, carrying meat M, are conveyed through a carbon monoxide treatment chamber 16 which may be a pressurized tunnel in one embodiment of the present invention. The chamber 16 is coupled to a source of carbon monoxide gas, an exhaust port, and a backfill port, as indicated in FIG. 1. The treated meat MT in the trays 14 then passes out of the carbon monoxide treatment chamber 16 and passes into a packaging and heat sealing machine 18. The machine 18 receives rolls of sealing film 20a which it cuts to shape and heat seals to the flanges of the trays 14 in one embodiment. Thus, the finished products 20c exit from the machine 18. The remaining film is taken up on a roll 20b as indicated.

According to one embodiment of the invention, fresh meat may be exposed to carbon monoxide in an air-tight chamber 16, in an atmosphere containing at least 0.1% to 10% carbon monoxide at a pressure of at least 1.1 bar above the atmospheric pressure for not more than seven hours. In one embodiment, the exposure may be for less than two hours and the exposure may be for about 15 minutes in one particular case. This exposure time may include time spent ramping up to one or more target pressures and ramping down from those pressures.

The carbon monoxide may be extracted from the chamber 16 to generate an ambient pressure within the chamber 16 of less than atmospheric pressure. The chamber 16 may be ventilated to allow the internal pressure to equilibrate to that of the atmospheric pressure. Then, the atmosphere surrounding the fresh meat may be evacuated, thereby removing any residual carbon monoxide from the fresh meat. The evacuated volume may be backfilled with a gas mixture substantially free of carbon monoxide.

In one embodiment, the fresh meat may be placed on a tray 14 covered with a heat sealed film 20c. The film may be a non-barrier material which, as used herein, means that the material transmits oxygen at a rate greater than 200 cc/100 square inches over 24 hours. A non-barrier material transmits 750 cc/100 square inches over 24 hours in one embodiment. A non-barrier film may also be used to cover the resulting package so that oxygen infiltration after carbon monoxide treatment may enhance the red color of the blooming meat.

In another embodiment, the tray 14 may be covered with a barrier film 20c which, as used herein, means that the material transmits oxygen at a rate of less than or equal to 200 cc/100 square inches in 24 hours. In one embodiment, the barrier material transmits oxygen at about 5 cc/100 square inches in 24 hours. In an embodiment using a barrier material, oxygen may be provided within the package initially to enhance the red bloom color. For example, about 1% of the gas provided to the package may include oxygen (O₂) gas and the balance may be nitrogen (N₂). The use of the barrier film 20c may be particularly advantageous when packaging ground meat.

The red color of the meat caused by the treatment with carbon monoxide may advantageously degrade before the meat is no longer suitable for human consumption due to microbiological spoilage. This generally occurs when the total anaerobic plate count (TPC) exceeds one million colony forming units (CFU/gram). In one embodiment, the meat may have an a* standard value of greater than 10 when it reaches a plate count of greater than one million. The a* color solid may be obtained from Hunter Lab, Reston, Va. 20190. Advantageously, the meat has a shelf life, after carbon monoxide exposure, of more than three days.

By extracting the atmosphere containing carbon monoxide from the chamber 16 and ventilating the chamber via the exhaust port, workers involved in the treatment may not be subjected to toxic levels of carbon monoxide. Finally, by additionally evacuating the atmosphere surrounding the fresh meat after ventilation of the chamber, residual carbon monoxide may be removed from the fresh meat. By this evacuation and the additional backfilling of the evacuated volume with a gas mixture substantially free of carbon monoxide, there may be little or no residual carbon monoxide in the packaged meat or in the packaged atmosphere surrounding the meat. As a result, the consumers of the meat may not be exposed to carbon monoxide.

In one embodiment, the fresh meat is placed in a tray 14, and exposed to carbon monoxide under pressure. The atmosphere contained within the tray 14 is evacuated, thereby removing residual carbon monoxide from the fresh meat. The evacuated tray 14 may be backfilled with a gas mixture substantially free of carbon monoxide. The tray 14 may be covered with a lidding material heat sealed to the tray. A non-barrier lidding material 20c may be formed, for example, of oriented polyolefin. The fresh meat in the tray 14 may be treated in the pressure chamber 16 or the fresh meat may be placed in the tray 14 after treatment and ventilating the chamber 16. The fresh meat may be removed from the chamber 16, as indicated at MT in FIG. 1, after ventilation and prior to packaging.

The tray 14 may be formed from a rigid plastic, such as polypropylene, semi-rigid plastic, such as expanded polystyrene, aluminum foil, or paperboard. The tray 14 may be a sufficient oxygen barrier and water vapor barrier to aid in prolonging the shelf life of the fresh meat. In particular the tray material may have an oxygen transmission rate of less than 10 cc per 100 square inch per 24 hours, preferably of less than 5 cc per 100 square inch per 24 hours, in particular of less than 1 cc per 100 square inch per 24 hours.

The balance of the treatment atmosphere containing carbon monoxide built up in the closed chamber 16 may be nitrogen (N₂) or may be any other suitable gas or mixture of gases. The backfilled gas mixture applied after carbon monoxide treatment and the evacuation of the carbon monoxide containing atmosphere may contain between approximately 20% and 50%, and, for example, approximately 30%, carbon dioxide (CO₂) and between approximately 50% and 80%, for example, approximately 70% nitrogen (N₂).

The pressure within the chamber 16 during the carbon monoxide exposure may be between approximately 1.1 and 15 bar resulting in a good compromise between a fast and a secure treatment.

The post-treatment evacuation process, with a non-barrier film, may be performed to a pressure of less than approximately 50 mbar, and, in one embodiment, at a pressure of less than approximately 10 mbar during the packaging of the fresh meat. With a barrier film, the evacuation process may be performed to a pressure of less than 100 mbar and above 48.46 mbar in one embodiment.

In addition, the inside of chamber 16 may be maintained at a temperature in the range from approximately 0° C. to 5° C. Additionally, the treated meat may be cooled during packaging and also during transportation from a central cutting/treating packaging facility to retail distribution centers in order to aid in prolonging the shelf life of the fresh meat.

The exposure time to carbon monoxide may be between approximately 5 minutes and 7 hours, for example, between approximately 10 minutes and 2 hours, and, in one particular embodiment, approximately 15 minutes. The exposure time may be chosen to achieve a desired depth of carbon monoxide penetration into the meat.

According to a further embodiment of the invention, the packaging of the fresh meat follows almost immediately after ventilation of the chamber 16. The time between treatment and packaging may be in the range of approximately 1 minute to 1 hour in one embodiment.

Individual retail portions of fresh meat M may be cut or ground from either primal or sub-primal cuts of fresh meat. The individual retail portions are placed into a preformed tray 14 made e.g., from rigid plastic, semi-rigid plastic, aluminum foil or paperboard as indicated at block 22 in FIG. 2. The preformed trays 14 have a sufficient oxygen barrier and water vapor area to aid in prolonging the shelf live of the fresh meat.

After this preparation step, the trays or other carriers transporting the fresh meat portions are placed into a pressure chamber 16 capable of generating internal pressures above 1.1 bar. The internal pressure of the chamber is elevated to the desired pressure, as indicated at 24 in FIG. 2, which may be about 15 bar in one embodiment. The gas employed to elevate the internal pressure of the chamber may have a carbon monoxide content of at least 0.1%, for example 5%, and a maximum carbon monoxide content of 10% in one embodiment. The balance of the gas or gases used to elevate the pressure within the chamber may, for example, be nitrogen (N₂).

It is possible to extract the environmental atmosphere from the chamber 16 before increasing the pressure by supplying the gas mixture containing carbon monoxide. A vacuum pump may be used for such an extraction to the environmental atmosphere may be displaced from the chamber by supplying the gas mixture containing carbon monoxide to the chamber and blowing out the environmental atmosphere through a suitable chamber opening.

The meat may remain in the pressure chamber 16 for a predetermined period of time, for example between 5 minutes and 7 hours, as indicated at 26 in FIG. 2, and at a temperature preferably ranging from 0° C. to 5° C.

Due to the pressure built up in the chamber 16, the carbon monoxide penetrates into the meat resulting in the generation of carbon-monoxide myoglobin (carboxymyoglobin) in the meat. This carboxymyoglobin buildup produces a stable red pigmentation normally associated with oxymyoglobin.

The carbon monoxide remaining in the chamber 16 may be reclaimed in order to remove carbon monoxide from the red meat and to retain carbon monoxide from the chamber for re-use. This can, for example, be accomplished by the use of a mechanical vacuum pump employed to evacuate the gas content of the chamber to an ambient pressure within the chamber of a pressure less than atmospheric pressure as indicated at 28 in FIG. 2. In addition, by removing the carbon monoxide from the chamber 16, the workers opening the chamber after the treatment will be less likely to be exposed to carbon monoxide.

After the evacuation process, the internal pressure of the chamber 16 may be less than the external atmospheric pressures surrounding the chamber. Therefore, the pressure chamber 16 may be ventilated to allow the internal pressure to equilibrate to that of the external atmospheric pressure as indicated at 30 in FIG. 2.

Subsequently, the carbon monoxide treated meat cuts MT may be removed from the pressure chamber 16 and transported to a packaging device 18 as indicated at 32. In the packaging device 18, the atmosphere may be evacuated to a level less than 50 mbar to remove residual carbon monoxide, which penetrated the meat, but was not involved in the generation of carbon-monoxide myoglobin as indicated at 34.

After the evacuation process, the evacuated volume may be backfilled with a gas mixture of approximately 30% carbon dioxide (CO₂) and 70% nitrogen (N₂) as indicated at 36.

Subsequently, the preformed tray supporting the treated meat is heat sealed with a lidding material as indicated at 38. The finished individual packages of pretreated meat are then transported under refrigeration from the central cutting/treating/packaging facility to retail distribution centers.

The packaged meat may be exposed to oxygen, as indicated at 40, to enhance the bloom. This may be accomplished via the non-barrier film 20c from the atmosphere in one embodiment. With a barrier film, oxygen (e.g., 1%) may be added into the package with the backfill.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
treating meat with a carbon monoxide atmosphere for less than 7 hours at a carbon monoxide concentration of above 0.1%.

2. The method of claim 1 including treating the meat within a tray.

3. The method of claim 2 including covering said tray with a barrier film after treatment of the meat.

4. The method of claim 2 including covering said tray with a non-barrier film.

5. The method of claim 1 including packaging the meat and trapping carbon dioxide within the package.

6. The method of claim 1 including exposing the packaged meat to oxygen.

7. The method of claim 6 including exposing the packaged meat to oxygen after packaging.

8. The method of claim 6 including exposing the packaged meat to oxygen during packaging.

9. The method of claim 1 including preventing the meat from maintaining a bloomed color for longer than the time that it is fit for human consumption.

10. The method of claim 1 including treating said meat with carbon monoxide under pressure.

11. The method of claim 10 including treating the meat with gas including carbon monoxide at a pressure greater than 1.1 bar above atmospheric pressure.

12. The method of claim 11 including treating said meat with carbon monoxide under pressure of about 15 bar over atmospheric pressure.

13. The method of claim 12 including treating with a gaseous atmosphere including about 5% carbon monoxide.

14. The method of claim 1 including covering said meat with a barrier film having a gas transmission rate less than 200 cc/100 square inches in 24 hours.

15. The method of claim 1 including packaging said meat to have a shelf life greater than 3 days with an a* value of greater than 10 at a total anaerobic plate count of one million colony forming units per gram.

16. The method of claim 15 including treating with carbon monoxide and nitrogen atmosphere.

17. The method of claim 10 including treating said meat with carbon monoxide for less than two hours.

18. The method of claim 17 including treating the meat with pressurized carbon monoxide for approximately 15 minutes.

19. The method of claim 1 including packaging said meat in an atmosphere substantially free of carbon monoxide.

20. The method of claim 19 including exposing the treated meat to a pressure lower than atmospheric pressure to drive off excess carbon monoxide.

21. The method of claim 20 including packaging said meat after removing excess carbon monoxide.
